(19) United States
(12) Patent Application Publication
(10) Pub. No.: US 2002/0087629 A1
(43) Pub. Date: Jul. 4, 2002

(54) Receiving coded information

(76) Inventor: Ronaldus Maria Aarts, Eindhoven (NL)

Correspondence Address: Philips Electronics North America Corporation, 580 White Plains Road, Tarrytown, NY, 10591, US

(21) Appl. No.: 10/014,860

(22) Filed: Nov. 13, 2001

(30) Foreign Application Priority Data
Nov. 14, 2000 (EP) 00203993.1

(51) Int. Cl. G06F 15/16

(52) U.S. Cl. 709/203

(57) ABSTRACT

One of the items that is coming up lately is that the content information is coded before it has been sent to the user. The user of the content information only wants to pay for the content information when he knows for what content information he is paying.

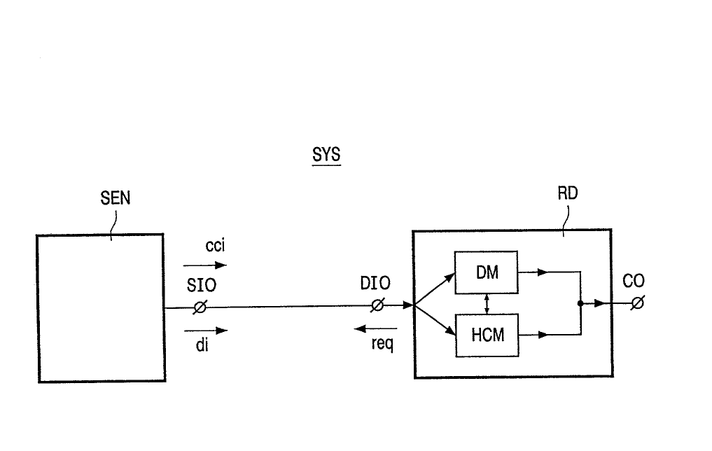

So, this dilemma exists between the producer (SEN) and the user (RD) of content information. The invention provides a method and a device (SEN) able to supply coded content (cci) information and at the other hand giving the user the possibility to decide whether or not he wants to receive (req) the decoded content information (dc).

After decoding the content information the user can listen or view the content information (co) at full quality.

The invention relates to a method and a device for reproducing received content information.

Such a method and device are well-known in the art and are, for example, used to reproduce audio signals or television signals etc.

One of the items that is coming up lately is that the content information is coded before it has been sent to the user.

Further with using internet also coded content information is distributed. When selling via the Internet the producer of the content information wishes to make sure that after he has spread the content information the user will pay for this content information. One of the possibilities to achieve this is by coding this content information.

On the other hand the user of the content information only wants to pay for the content information when he knows for what content information he is paying.

So, this dilemma exists between the producer and the user of content information.

It is an object of the invention to provide a method and device overcoming the disadvantageous of the prior art. To this end a method according to the invention comprises the features of claim 1.

A second aspect of the invention provides a device comprising the features of claim 3.

According to the invention the user receives coded content information but is in the position to reproduce this content information, for example, with a low quality but at the same time giving an impression of the content information.

After he has decided that he wants the uncoded content information, that is, for example, at full quality, a signal is send to the producer (sender of the content information) indicating that he wants to receive and in most cases to pay for the decoded content information.

To overcome that the sender has to send the complete decoded content information the sender can, for example, only send decoding information to the user which makes it possible to decode the content information at his side.

Or the sender can supply the missing part of the content information for example the least significant bits in case the content information is coded in such a way. After decoding the content information the user can listen or view the content information at full quality.

Embodiments of the invention are described in the dependent claims.

These and other aspects of the invention will be apparent from elucidated with reference to examples described hereinafter. Herein shows:

The FIGURE a block schematic example of a system with a device for reproducing received content information according to the invention.

The FIGURE shows block schematic a system SYS comprising a sender SEN for sending the content information and a reproducing device RD for reproducing the content information.

The sender SEN comprises a sender I/O SIO for supplying as an output signal the coded content information cci and for supplying as an output signal the decoding information di.

After the receiver (user) has decided that he wants to receive the decoded information, the receiver sends a signal req to the sender. The sender I/O receives the request req to supply the decoding information di from the reproducing device RD.

The reproducing device comprises a device I/O for receiving the coded content information cci and decoding information di from the sender SEN. The reproducing device RD further comprises a content output CO for supplying content information to for example a display (in case of pictures, video etc) and/or loudspeakers (in case of audio).

Further the reproducing device RD comprises means to handle the coded information HCM and decoding means DM for decoding the coded content information.

After decoding the decoded content information can be supplied to a display and/or loudspeakers etc. It will be noticed that above an embodiment of the inventor is described. All kind of amendments can be performed without departing from the core of the invention.

The term “coded” must in this application be understood as meaning “not giving the user the information he needs”. This can be, for example:

give just a part of the information enough to decide whether you want to receive the rest (and, for example, pay for the rest).

give more than wanted and pay for deleting a part (for example, Karaoke).

give just a first part of music, film, etc. (pay for the rest).

give only pictures of film (not the sound, for which has to be paid)

1. Method of reproducing received content information comprising the steps of
a step of receiving coded content information (cci) from a sender (SEN),
a step of reproducing the received coded content information (cci),
a step of deciding whether or not the decoded content information should be received,
a step of sending a signal (req) indicating that decoding information should be sent by the sender,
a step of receiving decoding information (di)
a step of decoding the coded content information (DM) and
a step of reproducing the decoded content information.

2. Method according to claim 1 characterized in that the step of decoding the coded content information comprises the adding of least significant bits of the content information.

3. Device for reproducing received content information comprising
an input for receiving an input signal from a sender of content information,
an output for supplying an output signal,
means (HCM) for handling coded content information in the input signal and reproducing this coded content information (cci),
means to send a signal (req) to the sender requesting to send decoding information, and
means (DM) to decode the coded content information and to supply and reproduce the decoded content information to the output of the device.

4. Device according to claim 3, characterized in that the means to decode the coded content information comprises adding the least significant bits of the content information.
